(19) United States
(12) Patent Application Publication
(10) Pub. No.: US 2023/0009957 A1
(43) Pub. Date: Jan. 12, 2023

(54) VOICE TRANSLATION AND VIDEO MANIPULATION SYSTEM

(71) Applicant: Voice.ai, Inc., Draper, UT (US)

(72) Inventor: Heath Ahrens, Draper, UT (US)

(73) Assignee: Voice.ai, Inc, Draper, UT (US)

(21) Appl. No.: 17/858,640

(22) Filed: Jul. 6, 2022

Related U.S. Application Data
(60) Provisional application No. 63/219,216, filed on Jul. 7, 2021.
(60) Provisional application No. 63/282,792, filed on Nov. 24, 2021.

(51) Int. Cl. G10L 21/007; G10L 15/00; G10L 15/04; G06F 40/166; G10L 15/22; G10L 15/26

(52) U.S. Cl. CPC G10L 21/007; G10L 15/005; G10L 15/04; G06F 40/166; G10L 15/22; G10L 15/26

(57) ABSTRACT

A communication modification system including an audio gathering unit that gathers an audio stream, a language detection unit that converts the audio stream into text, where the language detection unit correlates portions of the text with audio portions of the audio stream, and the language detection unit determines a first and second deviation in the audio stream portion based on the text portion and audio portion gathered by the audio gathering unit.

### CROSS-REFERENCE TO RELATED APPLICATIONS

The present disclosure is a continuation of U.S. Provisional Patent Application No. 63/219,216, filed on Jul. 7, 2021, and U.S. Provisional Patent Application 63/282,792, filed on Nov. 24, 2021, each of which is incorporated by reference in its entirety.

### BACKGROUND OF THE INVENTION

As video communications become more widespread and international, parties speaking a multitude of languages may be involved in a call. Because of the variety of different languages involved, translation of audio as a speaker speaks becomes more critical. Without using a translator present on a call, conducting a call involving people of differing languages make communication impossible.

Therefore, a need exists for a method of translating audio in real time while also adjusting a user's video to correspond to a translation.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure may disclose a communication modification system including an audio gathering unit that gathers an audio stream, a language detection unit that converts the audio stream into text, where the language detection unit correlates portions of the text with audio portions of the audio stream, and the language detection unit determines a first and second deviation in the audio stream portion based on the text portion and audio portion gathered by the audio gathering unit.

In another embodiment, text may be broken into individual words or phrases.

In another embodiment, the individual phrases and words may be logically related to auto segments of the audio stream.

In another embodiment, each audio segment may be analyzed to determine at least one speech characteristic.

In another embodiment, the speech characteristic may be one of dialect, speed, emotion or any other characteristic detectable in the audio stream.

In another embodiment, a first deviation algorithm may be determined based on the speech characteristic on at least one audio segment.

In another embodiment, the first deviation algorithm may be applied to at least one audio segment to product a modified audio segment, with the modified audio segment being analyzed to identify additional speech characteristics.

In another embodiment, a second deviation algorithm may be determined using the modified audio segment.

In another embodiment, a second modified audio segment may be generated using the second deviation algorithm.

In another embodiment, the first and second deviation algorithms may be applied to all audio segments to produce a modified audio stream.

Another embodiment of the present disclosure may disclose a method modifying an audio stream including the steps of gathering an audio stream via an audio gathering unit, converting the audio stream into text using a language detection unit, correlating portions of the text with audio portions of the audio stream, and determining a first and second deviation in the audio stream portion based on the text portion and audio portion gathered by the audio gathering unit.

Another embodiment includes the step of breaking the text into individual words or phrases.

Another embodiment includes the step of logically replating the individual phrases and words auto segments of the audio stream.

Another embodiment includes the step of analyzing each audio segment to determine at least one speech characteristic.

Another embodiment includes the step of detecting at least one speech characteristic including dialect, speed, emotion or any other characteristic detectable in the audio stream.

Another embodiment includes the step of determining a first deviation algorithm in at least one audio stream segment based on the speech characteristic determine on each of the at least one audio segments.

Another embodiment includes the step of applying the first deviation algorithm to at least one audio segment to produce a modified audio segment and analyzing the modified audio segment to identify additional speech characteristics.

Another embodiment includes the step of determining a second deviation algorithm using the modified audio segment.

Another embodiment includes the step of generating a second modified audio segment using the second deviation algorithm.

Another embodiment includes the step of applying the first and second deviation algorithms to all audio segments to produce a modified audio stream.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a data aggregation and analysis system 100 consistent with the present invention;

FIG. 2A depicts one embodiment of a data aggregation and analysis unit 102;

FIG. 2B depicts one embodiment of a communication device consistent with the present invention;

FIG. 3 depicts a schematic representation of a process of translating a transmission between communication devices; and

FIG. 4 depicts a schematic representation of a process of converting a user's voice to a second voice and converting the second voice to a third voice.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The voice translator system gathers information on the audio and video streams of a video communication. The audio and video are parsed, and the audio is translated into a foreign language and the video is manipulated such that the mouths of the users mimic the user speaking the foreign language.

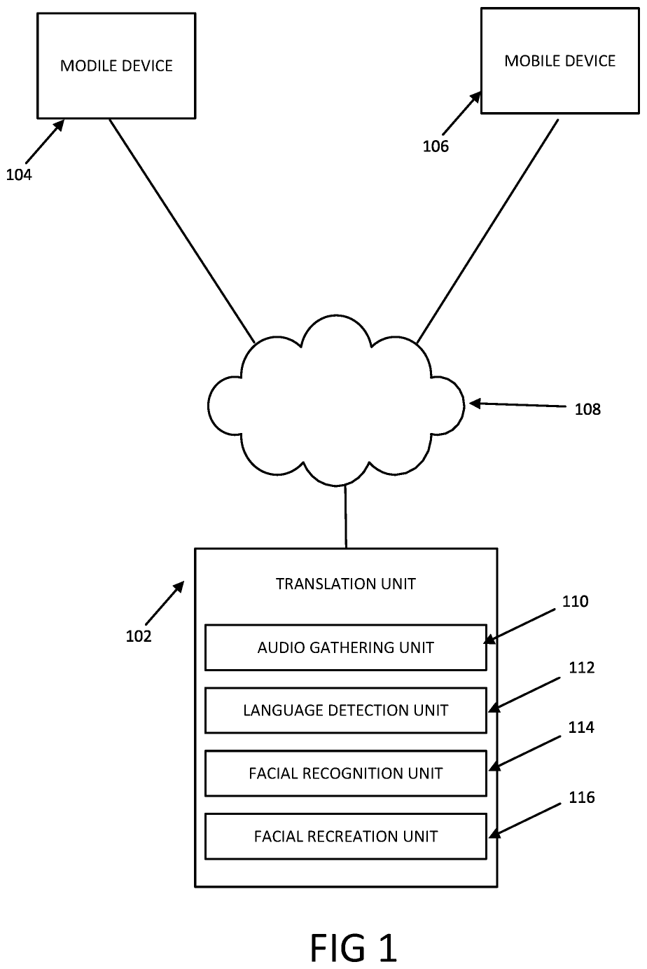

FIG. 1 depicts one embodiment of a voice translation system 100 consistent with the present invention. The translation system 100 includes a translation unit 102, a communication device 1 104, a communication device 2 106 each communicatively connected via a network 108. The voice translation unit 102 further includes an audio gathering unit 110, a language detection unit 112, a facial recognition unit 114, and a facial recreation unit 116.

The audio gathering unit 110 and language detection unit 112 may be embodied by one or more servers. Alternatively, each of the facial recognition unit 114 and facial recreation unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the voice translation unit 102 may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network, or any suitable network, using standard communication protocols. The network 108 may include hardwired as well as wireless branches.

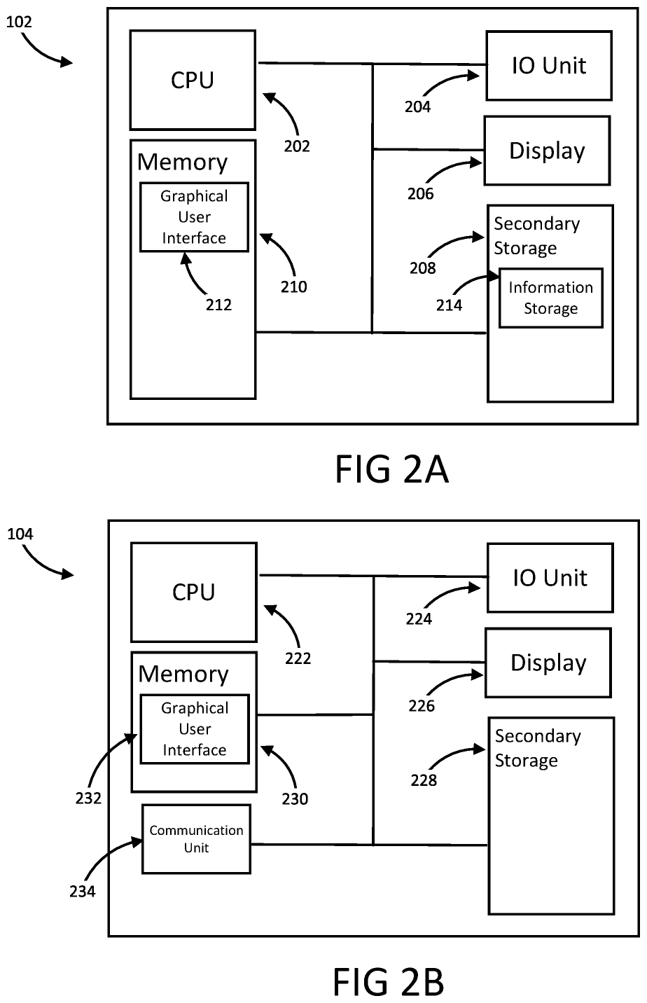

FIG. 2A depicts one embodiment of a voice translation unit 102. The voice translation unit 102 includes a network I/O device 204, a processor 202, a display 206 and a secondary storage 208 running image storage unit 210 and a memory 212 running a graphical user interface 214. The language detection unit 112, operating in memory 208 of the voice translation unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device.

FIG. 2B depicts one embodiment of a communication device 104/106 consistent with the present invention. The communication device 104/1106 includes a processor 222, a network I/O Unit 224, a display 226, a secondary storage unit 228, memory 230 running a graphical user interface 232 and a communication unit 234. In one embodiment, the processor 222 may be a central processing unit (“CPU”), an application specific integrated circuit (“ASIC”), a microprocessor or any other suitable processing device. The memory 230 may include a hard disk, random access memory, cache, removable media drive, mass storage or configuration suitable as storage for data, instructions, and information. In one embodiment, the memory 230 and processor 222 may be integrated. The memory may use any type of volatile or non-volatile storage techniques and mediums. The network I/O device 224 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network, or any suitable network, using standard communication protocols. The network 108 may include hardwired as well as wireless branches.

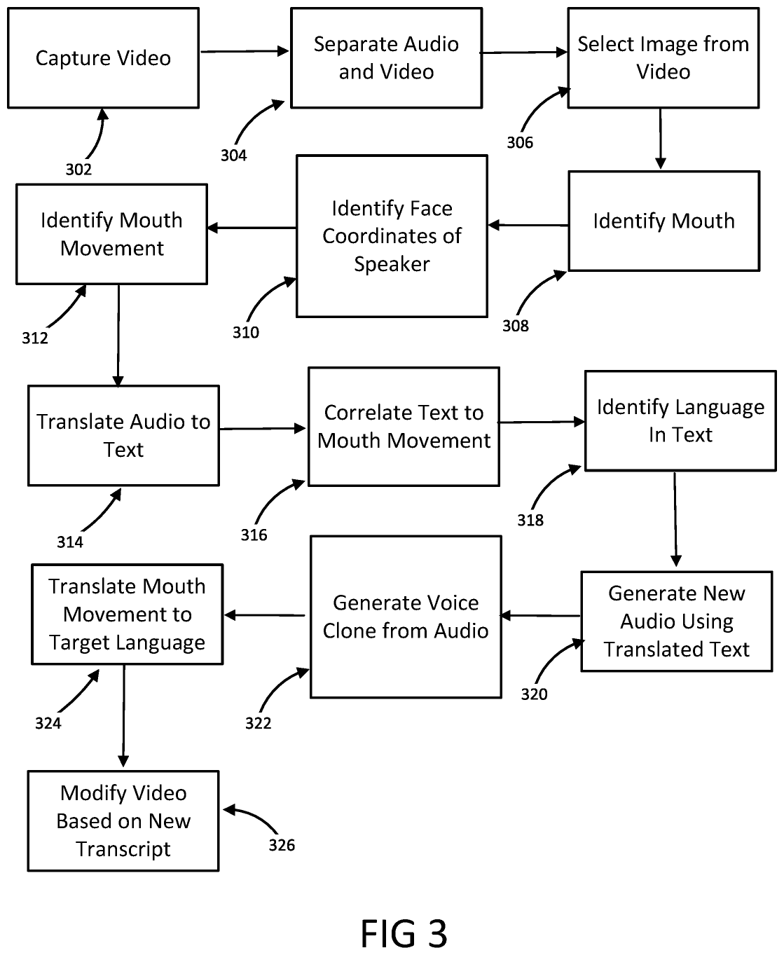

FIG. 3 depicts a schematic representation of a process of translating a transmission between communication devices 104/106. In step 302, a video stream is captured by the audio gathering unit 110. The video stream may be a saved video stream of a video stream captured in real time. In step 304, the audio and video portions of the video stream are separated by the audio gathering unit 110. In step 306, the facial recognition unit 114 selects an image of a face from the video stream. The facial recognition unit 114 may use any known face detection algorithm to detect a face in an image. In step 308, the facial recognition unit 114 identifies the mouth on the image gathered previously. In step 310, facial recognition unit 114 identifies the coordinates of the speakers face. In step 312, the facial recognition unit 114 compares adjacent images to identify movement characteristics of the mouth. In step 314, the audio gathering unit 110 translates the captured audio into text. In step 316, the facial recognition unit 114 correlates the converted text to the mouth movements in the video. As an illustrative example, the facial recognition unit 114 may begin with the first frame of the video and correlate the movement with the mouth in successive images with a word in the text. The facial recognition unit 114 may perform this identification for each word in the text and may store the specific images of each mouth movement with the text. In another embodiment, the facial recognition unit 114, any correlate the formation of specific letters and sounds with specific mouth movements captured in the video.

In step 318, the language detection unit 112 detects the language spoken in the video stream. In step 320, the audio gathering unit 110 generates a new audio stream using the translated text. In step 322, the audio gathering unit 110 uses digital audio processing to identify specific speech patterns of the speaker in the original audio stream and applies the speech patterns to the newly generated audio stream. The speech patterns are normalized and the applied the translated audio stream such that the audio stream is manipulated to match the speakers voice to the pronunciations in the converted text. In step 324, the pixels representing the mouth of the speaker are manipulated to replicate the movement of the speaker's mouth saying the newly translated text. The facial recreation unit 116 modifies the pixels representing the speaker's mouth in the video based on previously observed formations of the mouth while the speaker was dictating the original untranslated text. In step 326, the facial creation unit 116 modifies all frames of the video to correspond with the mouth movements for the translate text.

In addition to translating and replicated the movements of the speaker's mouth, emotions represent a large portion of communication. In one embodiment, after the face coordinates are identified, the audio gathering unit 110 may determine the emotions conveyed by the speaker and may adjust the speaker's image to convey to the speaker's emotional state. In one embodiment, the audio gathering unit 110 may determine the emotional state of the speaker by analyzing the volume and speed of the audio as well as the facial coordinates of the speaker while speaking.

As an illustrative example, a first user on a communication device 104 calls a user on a second communication device 106 with the first user initiating a video call. Each user selects their native language and the audio gathering unit 110 translates the audio in the preferred language of each user. In addition, the mouth images of each user are adjusted to mimic each user saying the words in the other user's preferred language.

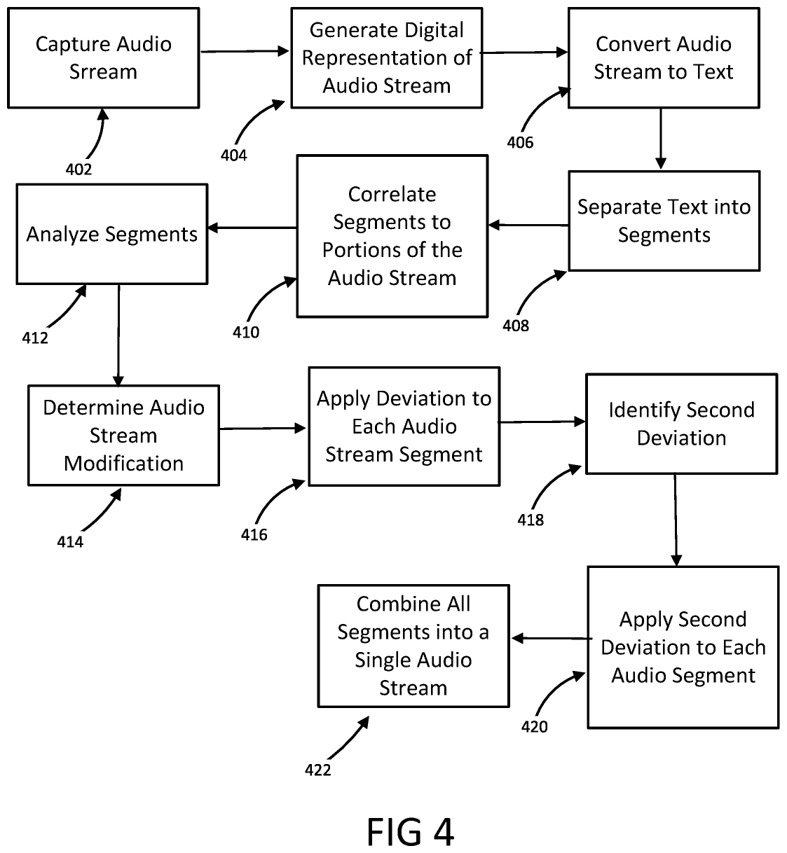

FIG. 4 depicts a schematic representation of a method of converting a voice. In step 402, an audio stream is captured by the audio gathering unit 110. In one embodiment, the audio stream is the voice of a user of a communication device 104/106. In step 404, the audio stream is converted into a digital format by the audio gathering unit 110 using any known digital conversion method. In step 406, the audio stream is converted into text by the language detection unit 112. In step 408, the text is separated into sections. In one embodiment, the sections correspond to a single word. In another embodiment, the sections correspond to a phrase. In another embodiment, some sections correspond to words while other sections correspond to phrases. In step 410, the language detection unit 112 correlates the sections of text with related audio portions. As an illustrative example, the language detection unit 112 correlates the text of a word with the portion of the audio where the word is spoken. In one embodiment, the language detection unit 112 corelates the text to the audio using the timing sequence of the audio stream.

In step 412, the language detection unit 112 analyzes each segment of the correlated audio segments to determine the voice characteristics in each segment. In step 414, the language detection unit 112 determines the characteristics of each segment that is adjusted based on a predetermined audio output format. The characteristics includes, but is not limited to, speed of speech, tone, pronunciation of letters and words, and any other voice characteristic. In step 416, the language detection unit 112 adjusts the voice characteristics of each audio segment to generate a modified audio output. In step 418, a second audio deviation is determined based on user input. In step 420, language detection unit applies the second deviation to each audio segment. In step 422, the language detection unit 112 combines all the segments into a single audio segment.

As an illustrative example, the process may be used to generate an audio output that receives a user's voice and modifies the user's voice to simulate another person's voice. By applying the second deviation, the modified user's voice can be further modified to sound similar to a third person's voice.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A communication modification system including:
an audio gathering unit that gathers an audio stream;
a language detection unit that converts the audio stream into text,
wherein,
the language detection unit correlates portions of the text with audio portions of the audio stream,
the language detection unit determines a first and second deviation in the audio stream portion based on the text portion and audio portion gathered by the audio gathering unit.

2. The communication modification system of claim 1 wherein text is broken into individual words or phrases.

3. The communication modification system of claim 2 wherein the individual phrases and words are logically related to auto segments of the audio stream.

4. The communication modification system of claim 3 wherein each audio segment is analyzed to determine at least one speech characteristic.

5. The communication modification system of claim 4 wherein the speech characteristic is one of a dialect, a speed, an emotion or any other characteristic detectable in the audio stream.

6. The communication modification system of claim 5 wherein a first deviation algorithm is determined based on the speech characteristic in at least one audio segment.

7. The communication modification system of claim 6 wherein, the first deviation algorithm is applied to at least one audio segment to produce a modified audio segment, and the modified audio segment is analyzed to identify additional speech characteristics.

8. The communication modification system of claim 7 wherein a second deviation algorithm is determined using the modified audio segment.

9. The communication modification system of claim 8 wherein a second modified audio segment is generated using the second deviation algorithm.

10. The communication modification system of claim 9 wherein the first and second deviation algorithms are applied to all audio segments to produce a modified audio stream.

11. A method modifying an audio stream including the steps of:
gathering an audio stream via an audio gathering unit;
converting the audio stream into text using a language detection unit,
correlating portions of the text with audio portions of the audio stream
determining a first and second deviation in the audio stream portion based on the text portion and audio portion gathered by the audio gathering unit.

12. The method of claim 11 including the step of breaking the text into individual words or phrases.

13. The method of claim 12 including the step of logically replating the individual phrases and words auto segments of the audio stream.

14. The method of claim 13 including the step of analyzing each audio segment to determine at least one speech characteristic.

15. The method of claim 14 including the step of detecting at least one speech characteristic including dialect, speed, emotion or any other characteristic detectable in the audio stream.

16. The method of claim 15 including the step of determining a first deviation algorithm in at least one audio stream segment based on the speech characteristic determine on each of the at least one audio segments.

17. The method of claim 16 including the step of applying the first deviation algorithm to at least one audio segment to produce a modified audio segment and analyzing the modified audio segment to identify additional speech characteristics.

18. The method of claim 17 including the step of determining a second deviation algorithm using the modified audio segment.

19. The method of claim 18 including the step of generating a second modified audio segment using the second deviation algorithm.

20. The method of claim 19 including the step of applying the first and second deviation algorithms to all audio segments to produce a modified audio stream.
